(19) United States
(12) Patent Application Publication
(10) Pub. No.: US 2026/0241866 A1
(43) Pub. Date: Aug. 20, 2026

(54) VEHICLE STORAGE SYSTEM

(71) Applicant: Ford Global Technologies, LLC, Dearborn, MI (US)

(72) Inventors: Eduardo Enrique Garcia Ortega, Mexico City (MX); Humberto Memetla Martinez, Mexico City (MX); Ana Paola Perez Resendiz, Mexico City (MX); Diego Ernesto Gonzalez Espinosa, Naucalpan de Juarez (MX); Jose Nicolas Juarez Espinoza, Mexico City (MX); Eduardo Daniel Mejía Caballero, Mexico City (MX)

(73) Assignee: Ford Global Technologies, LLC, Dearborn, MI (US)

(21) Appl. No.: 19/055,198

(22) Filed: Feb. 17, 2025

(51) Int. Cl. B60R 5/04

(52) U.S. Cl. CPC B60R 5/04

(57) ABSTRACT

A storage system includes a storage bin having a front wall, a rear wall, a pair of laterally spaced side walls, a bottom wall, and a rim defining a top access opening. The storage bin is configured to be coupled to a storage area of a vehicle, the storage bin defining a storage space. The storage space includes a lower compartment, an upper compartment located above the lower compartment, and a load floor. The load floor is configured to separate the storage space into the upper and lower compartments when the load floor is in a first position, separate the storage area from the storage space of the storage bin when the load floor is in a second position, and uncover the top access opening to expose the storage space to the storage area when the load floor is in a third position.

### FIELD OF THE DISCLOSURE

The present disclosure generally relates to vehicle storage solutions and, more specifically, to multi-purpose storage systems for a storage area of a vehicle.

### BACKGROUND OF THE DISCLOSURE

Modern vehicles are often equipped with one or more storage spaces. In automobiles, specifically, front and rear storage areas are commonplace. Some vehicles include additional storage technology, particularly in a vehicle trunk space, such as grocery dividers made to partition a floor of the trunk space when in use, hidden storage compartments below the trunk space floor, and additional storage bins proximate to one or more storage spaces. However, even with such solutions, vehicle storage spaces are generally limited. Consumers of vehicles may desire a storage system to optimize vehicle storage spaces and increase utility and/or possible use cases of storage technology therein. There is therefore a need for additional enhancements in the characteristics and features of multi-purpose vehicle storage systems.

### SUMMARY OF THE DISCLOSURE

According to a first aspect of the present disclosure, a storage system includes a storage bin having a front wall, a rear wall, a pair of laterally spaced side walls, a bottom wall, and a rim defining a top access opening, wherein the storage bin is coupled to a storage area of a vehicle. The storage bin defines a storage space including a lower compartment, an upper compartment located above the lower compartment, and a load floor configured to separate the storage space into the upper and lower compartments when the load floor is in a first position, separate the storage area from the storage space of the storage bin when the load floor is in a second position, and uncover the top access opening to expose the storage space to the storage area when the load floor is in a third position, wherein the load floor is removably coupled to the bin in the first, second, and third positions, and wherein the load floor extends substantially vertically when in the third position.

Embodiments of the first aspect of the present disclosure can include any one or a combination of the following features:

a protuberance extending laterally into the storage space of the storage bin from each of the pair of laterally spaced side walls, wherein the pair of protuberances are spaced from the front wall, and wherein the pair of protuberances are configured to support the load floor.

the load floor is positioned below the pair of protuberances in the first position; the load floor rests on the pair of protuberances in the second position; and the load floor interposes the pair of protuberances and the front wall in the third position.

a pair of side bins extending from the pair of laterally spaced side walls away from the storage space, wherein each of the pair of side bins has a side compartment and a side cover configured to separate the storage area and the side compartment.

the storage bin proximate the side walls is configured to couple to a climate system duct provided on a side panel of the vehicle.

the bottom wall of the storage bin has a drain port connecting a vehicle exterior with the storage space, wherein a one-way drain valve is removably secured in the drain port, and wherein the drain port is configured to receive an electrical cord that is external to the vehicle when the one-way drain valve is removed from the drain port.

the storage bin provides an intermediate ridge, wherein the intermediate ridge is situated below the pair of protuberances, and wherein the intermediate ridge is configured to receive the load floor in the first position.

the storage bin provides at least one handle grip situated on the rim of the storage bin, wherein the at least one handle grip is disposed under a liftgate scuff of the vehicle such that the at least one handle grip is hidden from view by a user.

According to a second aspect of the present disclosure, a vehicle storage system includes a storage bin provided in a storage area of a vehicle, wherein the storage area is at least partially defined by a floor panel of the vehicle and a pair of side panels of the vehicle, the storage bin further including a front wall, a rear wall, a pair of laterally spaced side walls, a bottom wall, a rim defining a top access opening, and an intermediate ridge interposing the bottom wall and the rim, wherein the storage bin is secured in the storage area. The storage bin further includes a storage space defined by the storage bin, the storage space including a lower compartment, an upper compartment located above the lower compartment, and a pair of protuberances laterally extending into the storage space from the pair of laterally spaced side walls, wherein the pair of protuberances are spaced from the front wall, and a load floor configured to lay on the intermediate ridge of the storage bin below the pair of protuberances and thereby partition the storage space into the upper and lower compartments when the load floor is in a first position, lay on the rim and thereby separate the storage area of the vehicle from the upper and lower compartments of the storage bin when the load floor is in a second position, and interpose the front wall and the pair of protuberances when in a vertical orientation and thereby uncover the top access opening to expose the storage space to the storage area when the load floor is in a third position, wherein the load floor is removably coupled to the bin in the first, second, and third positions.

Embodiments of the second aspect of the present disclosure can include any one or a combination of the following features:

the load floor has a handle situated proximate the rear wall when the load floor is in the first and second positions, wherein the handle is positioned away from the storage bin when the load floor is in the third position.

the load floor is flush with the floor panel of the vehicle when the load floor is in the second position.

a side bin extending from at least one of the pair of laterally spaced side walls away from the storage space, wherein the side bin includes a side compartment and a side cover configured to lay flush with the floor panel.

the storage bin further includes a support conduit extending laterally along the front wall between a pair of orifices, wherein the orifices are configured to couple to a climate system duct located on each of the pair of side panels of the vehicle.

the bottom wall of the storage bin defines a drain port configured to removably receive a drain valve, wherein the drain port is configured to receive an electrical cord extending from a vehicle exterior when the drain valve is not received by the drain port.

at least one handle grip is disposed on the storage bin proximate the rear wall, wherein the at least one handle grip is disposed under a liftgate scuff of the vehicle.

According to a third aspect of the present disclosure, a storage system includes a storage area of a vehicle defined by a floor panel, a pair of opposing side panels, a top panel, and a rear seating assembly, a storage bin having a front wall, a rear wall, a pair of laterally spaced side walls, a bottom wall, and a top access opening, wherein the front wall, the rear wall, and the pair of laterally spaced side walls define a rim of the storage bin at the top access opening, and wherein the storage bin is coupled to the storage area of the vehicle, and a storage space within the storage bin, the storage space having an upper compartment, a lower compartment, and a pair of protuberances spaced from the front panel and extending laterally into the storage space from the pair of laterally spaced side walls. The storage system further includes a load floor operable between a first position, wherein the load floor is disposed below the pair of protuberances, separating the storage space into the upper and lower compartments, a second position, wherein the load floor is supported by the rim, connecting the upper and lower compartments and separating the storage area of the vehicle from the storage space of the storage bin, and a third position, wherein the load floor is secured between the front panel and the pair of protuberances, exposing the storage space to the storage area, wherein a handle is disposed on the load floor, wherein the handle is situated proximate the rear wall of the storage bin when the load floor is in the first and second positions, and wherein the handle is situated away from the rear wall when the load floor is in the third position.

Embodiments of the third aspect of the present disclosure can include any one or a combination of the following features:

the load floor is substantially flush with the floor panel when the floor panel is in the second position.

the storage bin further includes a pair of side bins extending laterally from the pair of laterally spaced side walls, wherein each of the pair of side bins has a side cover configured to lay substantially flush with the floor panel.

the bottom wall of the storage bin defines a drain port configured to removably receive a drain valve, wherein the drain port is further configured to removably receive an electrical cord that is external to the vehicle when the drain valve has been removed from the drain port.

the storage bin provides an intermediate ridge situated below the pair of protuberances within the storage space, wherein the intermediate ridge substantially demarcates the upper and lower compartments of the storage bin, and wherein the load floor is configured to lay on the intermediate ridge when in the first position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a rear perspective view of a vehicle having a rear cargo area equipped with a vehicle storage system;

FIG. 2 is a side perspective view of a vehicle storage bin of the vehicle storage system;

FIG. 3A is an upper perspective view of the vehicle storage bin with a load floor in a first position;

FIG. 3B is an upper perspective view of the vehicle storage bin with the load floor in a second position;

FIG. 3C is an upper perspective view of the vehicle storage bin with the load floor in a third position;

FIG. 4 is a perspective view of the vehicle and the vehicle storage system where the storage bin is removed from the floor panel;

FIG. 5 is a top view of a lower bin of the storage bin; and

FIG. 6 is an upper perspective view of the vehicle storage system receiving an electrical cord through a drain port of the storage bin.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

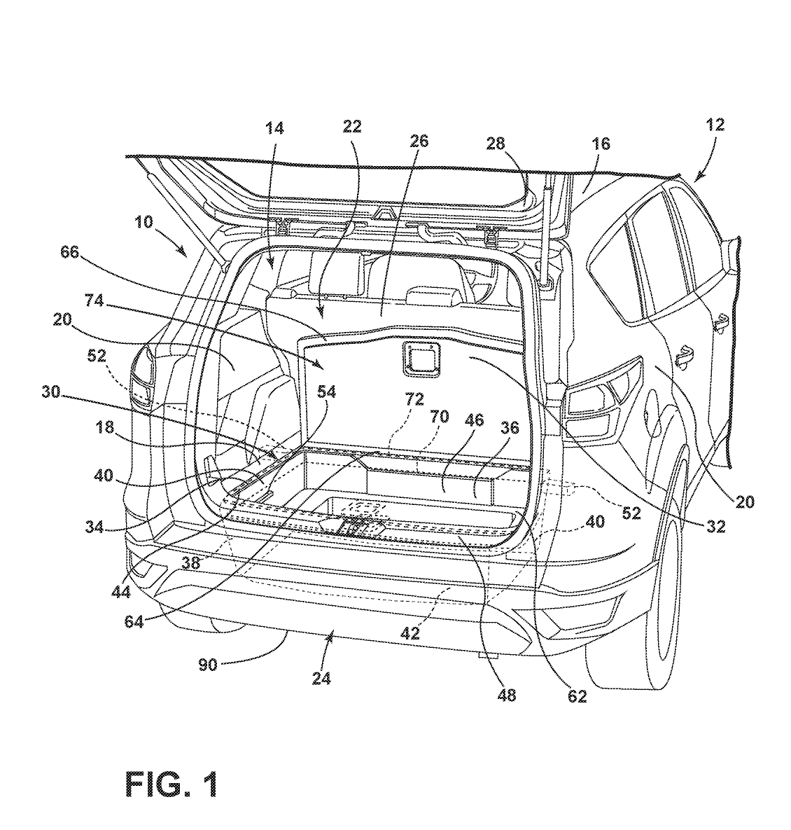

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle storage system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

With initial reference to FIG. 1, reference numeral 10 generally designates a storage system for a vehicle 12 having an interior space 14 at least partially defined by a top panel 16, a floor panel 18, and a pair of side panels 20. The vehicle 12 may be a motor vehicle such as a wheeled motor vehicle having a motor such as an internal combustion engine, an electric battery powered motor, or a hybrid having a combination of an internal combustion engine and an electric battery, for example. The interior space 14 includes a storage area 22 located proximate a vehicle rear end 24, the storage area 22 extending between a rear seating assembly 26 and the vehicle rear end 24, between the top and floor panels 16, 18, and between the pair of side panels 20. The storage area 22 is shown as a rear cargo area, in one example. The storage area 22 may otherwise be configured as a trunk in another example. The storage area 22 is accessible by a rear door 28 pivotally coupled to the vehicle 12 proximate the vehicle rear end 24, and the rear door 28 is pivotal between open and closed states. Within the storage area 22, the floor panel 18 extends between the rear seating assembly 26 and the vehicle rear end 24 and between the pair of side panels 20. The floor panel 18 is further configured to receive a storage bin 30. In alternative embodiments, the storage area 22 can be provided in another location within the vehicle 12, such as in a front trunk (hereinafter “frunk”), which is commonly available on battery electric vehicles. The location of the storage area 22 is also not limited to the interior space 14 of the vehicle 12, as the storage area 22 can otherwise be located in an exterior vehicle storage location, such as a truck bed.

The vehicle storage system 10 includes the storage bin 30 and a load floor 32 configured to cover a top access opening 34 of the storage bin 30. The storage bin 30 is configured to be received by the storage area 22 and secured within the floor panel 18 in the storage area 22. The storage bin 30 generally has a tub-shaped geometry and includes a front wall 36, a rear wall 38, a pair of laterally spaced side walls 40, and a bottom wall 42. When the storage bin 30 is secured within the floor panel 18, the front wall 36 is positioned proximate the rear seating assembly 26 and the rear wall 38 is positioned proximate the vehicle rear end 24. In other words, the rear wall 38 is positioned vehicle rearward relative to the front wall 36 when the storage bin 30 is secured within the floor panel 18 in the storage area 22. The laterally spaced side walls 40 extend longitudinally relative to the vehicle 12 between the front and rear walls 36, 38. Together, the front, rear, and side walls 36, 38, 40 also extend between the bottom wall 42 of the storage bin 30 and the top access opening 34 of the storage bin 30, and the front, rear, and side walls 36, 38, 40 define a rim 44 extending along a perimeter of the top access opening 34. The load floor 32 is further configured to selectively cover the top access opening 34 of the storage bin 30 by spanning across the top access opening 34, contacting the rim 44 of the storage bin 30, and isolating a storage space 46 within the storage bin 30 from the storage area 22. The load floor 32 is further configured to support a load when covering the top access opening 34 of the storage bin 30 and being supported by the rim 44 of the storage bin 30. The load floor 32 may have a construction including but not limited to a cardboard honeycomb body, glass fiber, and a polyurethane layer wrapped with carpet, for example.

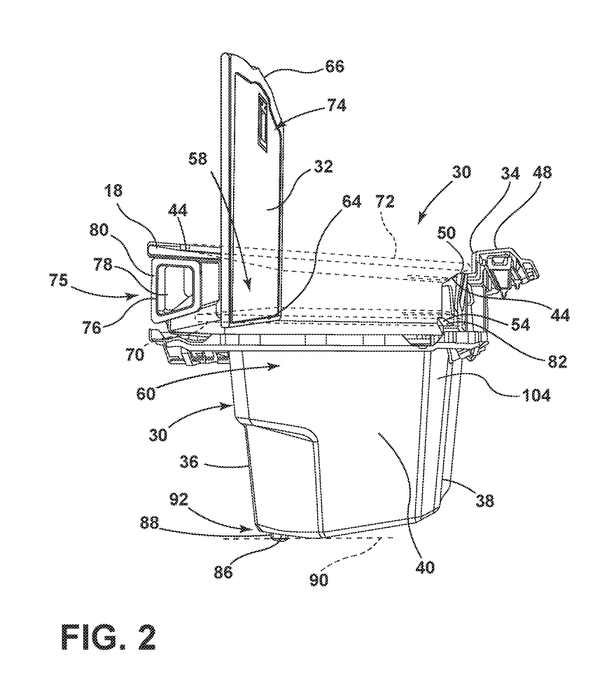

Still referring to FIG. 1, when the storage bin 30 is secured within the floor panel 18 in the storage area 22, the rim 44 of the storage bin 30 subsides below the floor panel 18 such that the load floor 32 is situated substantially flush with the floor panel 18 when covering the opening 34 of the storage bin 30. Alternatively, the rim 44 may protrude above the floor panel 18, be situated substantially flush with the floor panel 18, or subside below the floor panel 18 when secured by the floor panel 18. In some embodiments, the storage bin 30 may be integrally formed or interconnected with a liftgate scuff 48 provided at the vehicle rear end 24. Specifically, when the load floor 32 is covering the opening 34 of the storage bin 30, the load floor 32 may be supported by the front and side walls 36, 40 of the storage bin 30 and a ledge 50 of the liftgate scuff 48, and at least a portion of the rear wall 38 of the storage bin 30 may extend vehicle rearward relative to the ledge 50 (FIG. 2). According to one embodiment, the ledge 50 may be a portion of the rim 44. Moreover, the storage bin 30 spans part of the floor panel 18 in the storage area 22 when received by the floor panel 18. However, it is contemplated that the storage bin 30 may substantially span the entirety of the floor panel 18 when received by the storage area 22 or secured within the floor panel 18.

The storage bin 30 is further secured to a pair of climate control ducts 52. One of the pair of climate control ducts 52 is located on each of the pair of side panels 20, and each of the pair of climate control ducts 52 is in communication with the other climate control duct 52. It is contemplated that, alternatively, the climate control ducts 52 may not be connected to the storage bin 30 when the storage bin 30 is secured by the floor panel 18 in some embodiments. Accordingly, each of the pair of ducts 52 provided by the pair of side panels 20 may be in general communication with the storage area 22. The storage bin 30 may further be secured within the storage area 22 via one or more vehicle tie downs provided on each of the side panels 20 and/or the rear seating assembly 26.

With further reference to FIG. 1, the front, rear, side, and bottom walls 36, 38, 40, 42 of the storage bin 30 define the storage space 46. The storage bin 30 and the storage space 46 within the storage bin 30 may be tapered toward the bottom wall 42 of the storage bin 30 such that a cross-sectional area of the storage space 46 proximate the bottom wall 42 is smaller than the cross-sectional area of the storage space 46 proximate the top access opening 34. The storage space 46 may additionally be formed to accommodate design objectives and/or geometry constraints below the floor panel 18 of the vehicle 12, and therefore the front, rear, side, and bottom walls 36, 38, 40, 42 of the storage bin 30 may not be substantially planar. Furthermore, an intermediate ridge 54 is disposed on at least one of the side walls 40 of the storage bin 30, the intermediate ridge 54 being configured to support the load floor 32 in a position within the storage space 46 of the storage bin 30. According to some embodiments, the intermediate ridge 54 may additionally or alternatively be disposed on the front wall 36 and/or the rear wall 38 of the storage bin 30. Other support features in addition to or instead of the intermediate ridge 54 may be disposed on at least one of the front, rear, and side walls 36, 38, 40 of the storage bin 30 in the storage space 46 to support the load floor 32 in various positions. Such support features may extend continuously along the front, rear, and side walls 36, 38, 40 of the storage bin 30 parallel to the rim 44. Alternatively, the support features may be discontinuous and/or extend intermittently along the front, rear, and side walls 36, 38, 40 of the storage bin 30.

The storage space 46 within the storage bin 30 further includes an upper compartment 58 and a lower compartment 60. The upper compartment 58 is defined by the front, rear, and side walls 36, 38, 40 of the storage bin 30 extending between the top access opening 34 and the intermediate ridge 54. The lower compartment 60 is defined by the front, rear, and side walls 36, 38, 40 of the storage bin 30 extending between the intermediate ridge 54 and the bottom wall 42. While the front, rear, and side walls 36, 38, 40 of the storage bin 30 are substantially planar and continuous in the upper compartment 58, the front, rear, and side walls 36, 38, 40 of the storage bin 30 in the lower compartment 60 are discontinuous and are interrupted by an intermediate bottom wall 62. Consequently, the front, rear, and side walls 36, 38, 40 below the intermediate bottom wall 62 have smaller dimensions when compared to the dimensions of the front, rear, and side walls 36, 38 40 above the intermediate bottom wall 62 of the lower compartment 60. In other embodiments, the front, rear, and side walls 36, 38, 40 in the lower compartment 60 may be substantially planar and continuous, and/or the front, rear, and side walls 36, 38, 40 in the upper compartment 58 may be discontinuous, forming a different geometry of the storage space 46.

The load floor 32 of the vehicle storage system 10 is configured to modify the storage area 22 of the vehicle 12 and the storage space 46 of the storage bin 30, the load floor 32 defining a base end 64, a handle end 66, and a handle 68 proximate the handle end 66. The load floor 32 is operable between at least three positions in the current embodiment. The load floor 32 is in a first position 70 when the load floor 32 is substantially horizontal and partitions the storage space 46 of the storage bin 30 into the upper and lower compartments 58, 60. The load floor 32 sits below the rim 44 of the storage bin 30 when the load floor 32 is in the first position 70, and one or more support features, such as the intermediate ridge 54, support the load floor 32 in the first position 70. The load floor 32 is in a second position 72 when the load floor 32 separates the storage area 22 from the upper and lower compartments 58, 60 of the storage space 46, the load floor 32 being supported by the rim 44 of the storage bin 30. Furthermore, the load floor 32 has a substantially horizontal orientation and extends across the top access opening 34, sitting substantially flush with the floor panel 18 when in the second position 72. When the load floor 32 is in a third position 74, the load floor 32 is vertically oriented in the storage space 46, the load floor 32 being secured in the storage bin 30 proximate the front wall 36 such that the top access opening 34 is exposed, along with the upper and lower compartments 58, 60 of the storage space 46, to the storage area 22 of the vehicle 12.

With reference to FIG. 2, the storage space 46 of the illustrated storage bin 30 includes the lower compartment 60 and the upper compartment 58 situated above the lower compartment 60. The upper and lower compartments 58, 60 are generally demarcated by the intermediate ridge 54 and/or the load floor 32 when the load floor 32 is in the first position 70. In one embodiment, the lower compartment 60 has a larger volume than the upper compartment 58, yet such a configuration is intended to be nonlimiting. The front, rear, and side walls 36, 38, 40 of the storage bin 30 may further have different dimensions in each of the upper and lower compartments 58, 60 in alternative embodiments.

The rim 44 of the storage bin 30 is configured to receive the load floor 32 in the second position 72. The rim 44 is slightly recessed below the floor panel 18 such that the load floor 32 lays substantially flush with the floor panel 18 when resting on the rim 44 in the second position 72. The rim 44 is additionally recessed below the liftgate scuff 48 such that the load floor 32 is positioned below the liftgate scuff 48 when in the second position 72. In alternative embodiments, the liftgate scuff 48 may partially support the load floor 32 in the second position 72, where the load floor 32 may be substantially flush relative to the liftgate scuff 48. Notably, the load floor 32 may be slightly sloped toward or away from the liftgate scuff 48 in alternative embodiments.

The storage bin 30 includes a rectangular support conduit 75 situated below the rim 44 and extending along the front wall 36 of the storage bin 30. The support conduit 75 extends laterally along the front wall 36 of the storage bin 30 between a pair of orifices 76 situated at the opposing side walls 40 of the storage bin 30. Furthermore, each of the orifices 76 are coupled to one of the pair of climate control ducts 52 of the vehicle 12. The orifices 76 may be received by the ducts 52, receive the ducts 52, abut the ducts 52, secure to the ducts 52 via fasteners, and/or be otherwise integrated with the ducts 52. It is contemplated that the orifices 76 may be removably coupled to the climate control ducts 52. The pair of climate control ducts 52 are integrated into opposing side panels 20 of the vehicle 12, securing the storage bin 30 within the storage area 22 when the orifices 76 are coupled to the ducts 52. Furthermore, each of the pair of ducts 52 defines an air flow path 78 that is in communication with the support conduit 75. The support conduit 75 is defined by a support wall 80, the support wall 80 being integrated into the front wall 36 so as to make up a portion of the front wall 36. The support wall 80 protrudes into the storage space 46 and, specifically, into the upper compartment 58 of the storage bin 30. In some embodiments, the support wall 80 may be flush with the front wall 36 relative to the storage space 46 of the storage bin 30, and the support conduit 75 may extend from the front wall 36 away from the storage space 46 in a vehicle forward direction.

With further reference to FIG. 2, the load floor 32 is slidable along the intermediate ridge 54 underneath the support conduit 75. Specifically, the load floor 32 is slidable vehicle forward along the intermediate ridge 54 until the base end 64 of the load floor 32 is proximate the front wall 36 below the support conduit 75, and the load floor 32 may then be laid onto the intermediate ridge 54 such that the load floor 32 is in the second position 72. Particularly, the handle end 66 of the load floor 32 can be laid onto a rear portion 82 of the intermediate ridge 54 when the base end 64 of the load floor 32 is proximate the front wall 36 below the support conduit 75. The load floor 32 may need to be slid along the intermediate ridge 54 until the base end 64 of the load floor 32 abuts the front wall 36 below the support conduit 75 before the handle end 66 of the load floor 32 can be received by the rear portion 82 of the intermediate ridge 54. Notably, the base end 64 of the load floor 32 may be configured to abut the front wall at or above the support wall 80 of the support conduit 75 in some embodiments. It is also contemplated that the rear portion 82 of the intermediate ridge 54 may extend from the liftgate scuff 48.

The bottom wall 42 of the storage bin 30 defines a drain port 86 extending below the lower compartment 60 of the storage bin 30. The drain port 86 is positioned proximate the front wall 36 and one of the side walls 40 of the storage bin 30, and the drain port 86 defines a drain channel 88 connecting the storage space 46 of the storage bin 30 to a vehicle exterior 90. Preferably, the bottom wall 42 of the storage bin 30 defines the drain port 86 at a lowest portion 92 of the bottom wall 42 to enhance fluid and/or material egress. Depending on the configuration of the storage bin 30, the lowest portion 92 of the bottom wall 42 may vary. Additionally, the drain port 86 may not significantly extend below the bottom wall 42 of the storage bin 30.

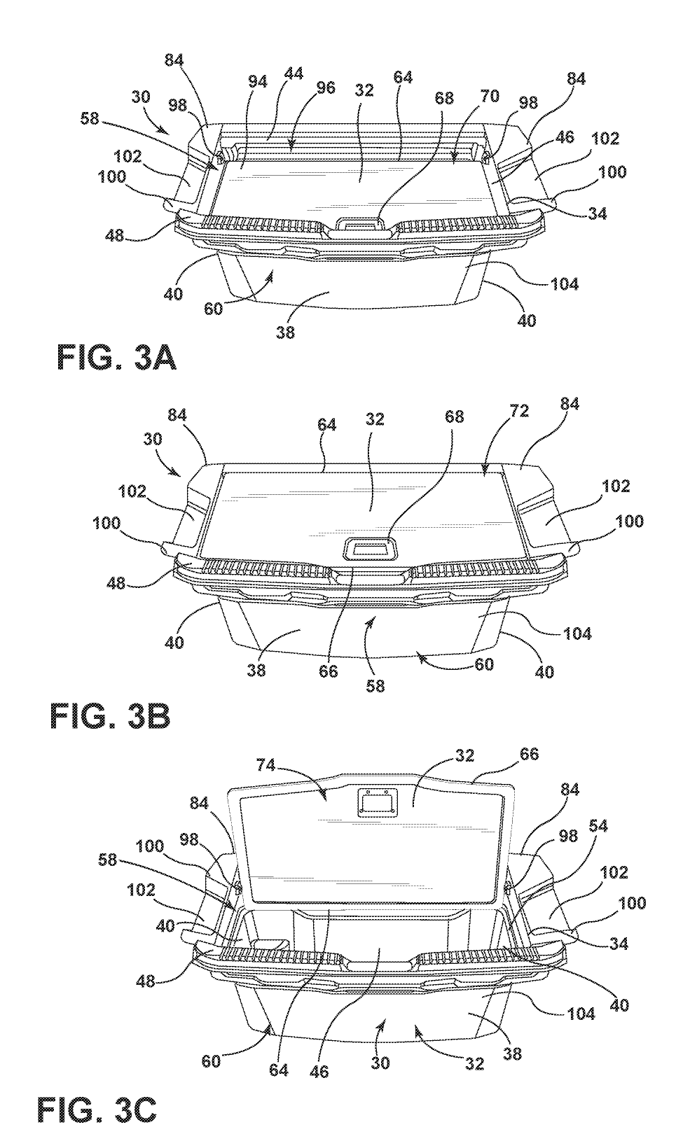

Referring now to FIG. 3A, the load floor 32 is in the first position 70. In the first position 70, the load floor 32 divides the upper and lower compartments 58, 60, and the load floor 32 lays substantially horizontal on the intermediate ridge 54 (FIG. 3C) running along the perimeter of the storage space 46 of the storage bin 30 below the upper compartment 58. The load floor 32 thus covers the lower compartment 60, in effect defining a secondary bottom wall 94 in the upper compartment 58 when the load floor 32 is in the first position 70. Additionally, the load floor 32 and the upper compartment 58 form a floor recess 96 in the floor panel 18. The floor recess 96 provides for a greater storage area volume exterior to the storage bin 30. The load floor 32 is further supported by the intermediate ridge 54 such that the load floor 32 may support a load. The intermediate ridge 54 may additionally be covered by a seal configured to be in contact with the load floor 32 when the load floor 32 is in the first position 70. Accordingly, the lower compartment 60 may be substantially water-tight when the load floor 32 is in the first position 70.

The storage space 46 of the storage bin 30 further provides a pair of protuberances 98, where one of the pair of protuberances 98 extends laterally into the storage space 46 from each of the pair of laterally spaced side walls 40. Each of the pair of protuberances 98 is spaced from the front wall 36 of the storage bin 30 such that the load floor 32 can be received between the front wall 36 and the pair of protuberances 98. Furthermore, the pair of protuberances 98 are positioned on the side walls 40 above the intermediate ridge 54 such that the load floor 32 can be received between the pair of protuberances 98 and the intermediate ridge 54. The pair of protuberances 98 generally assist with securing the load floor 32 in the first, second, and third positions 70, 72, 74. To move the load floor 32 into the first position 70, for example, the load floor 32 is slid onto and along the intermediate ridge 54 of the storage bin 30 beneath the pair of protuberances 98 until the base end 64 of the load floor 32 is proximate the front wall 36. Once the base end 64 of the load floor 32 is proximate the front wall 36, the handle end 66 of the load floor 32 can be lowered onto the rear portion 82 of the intermediate ridge 54 using the handle 68, thereby coupling the load floor 32 to the storage bin 30. Consequently, the pair of protuberances 98 obstruct the base end 64 of the load floor 32 from translating upward out of the storage bin 30 when the load floor 32 is in the first position 70. The load floor 32 is also slidable out from between the intermediate ridge 54 and the pair of protuberances 98 when the handle end 66 is sufficiently lifted off the intermediate ridge 54. In one embodiment, the handle end 66 must be raised above the floor panel 18 to enable sliding of the load floor 32 out from between the pair of protuberances 98 and the intermediate ridge 54. Once slid out from between the intermediate ridge 54 and the pair of protuberances 98, the load floor 32 may be moved to the second position 72, the third position 74, or another position such as one in which the load floor 32 is removed from the vehicle 12 altogether.

With reference now to FIG. 3B, the load floor 32 is in the second position 72. In the second position 72, the load floor 32 covers the upper and lower compartments 58, 60 of the storage space 46, thereby connecting the upper and lower compartments 58, 60 and separating the storage space 46 from the storage area 22. The load floor 32 sits substantially horizontally on the rim 44 of the top access opening 34 in the second position 72. In some embodiments, the load floor 32 additionally or alternatively sits on the pair of protuberances 98 and/or the ledge 50 of the liftgate scuff 48 (FIG. 2). The rim 44, the ledge 50, and/or the protuberances 98 in some embodiments are disposed in the storage space 46 such that the load floor 32 lays substantially flush with the floor panel 18 when in the second position 72 and when the storage bin 30 is secured by the floor panel 18. Compared to the load floor 32 in the first position 70, the load floor 32 in the second position 72 provides for an increased storage space volume and a decreased storage area volume. When moving the load floor 32 from another position into the second position 72, the load floor 32 is oriented horizontally and aligned over the top access opening 34 of the storage bin 30. The load floor 32 can then be laid, using the handle 68, onto the rim 44, the ledge 50, and/or the protuberances 98.

With reference to FIG. 3C, the load floor 32 is in the third position 74. In the third position 74, the load floor 32 has a substantially vertical orientation, where the base end 64 of the load floor 32 is below the handle end 66 of the load floor 32. The load floor 32 is secured between the pair of protuberances 98 and the front wall 36 of the storage bin 30 in the third position 74. When moving the load floor 32 into the third position 74 from another position, the vertically-oriented load floor 32 is slid between the pair of protuberances 98 and the front wall 36 until the base end 64 of the load floor 32 abuts the intermediate ridge 54 of the storage space 46. The base end 64 of the load floor 32 may be slid between the pair of protuberances 98 and the front wall 36 until the base end 64 of the load floor 32 abuts one or more support features in the storage space 46, such as the intermediate ridge 54 or the intermediate bottom wall 62 in some embodiments. In the third position 74, the load floor 32 does not cover the top access opening 34 of the storage bin 30, and the storage space 46, including the upper and lower compartments 58, 60, is in connection with the storage area 22, thereby effectively increasing the storage area 22. In some embodiments, the load floor 32 may have a substantially vertical orientation in the third position 74, or an orientation in which the load floor 32 is substantially aligned with the rear seating assembly 26. Furthermore, it is contemplated that the vehicle storage system 10 may comprise an additional floor(s), which may also separate the upper and lower compartments 58, 60 of the storage bin 30 when the load floor 32 is in the third position 74.

With reference to FIGS. 3A-3C, the storage system 10 further provides the pair of side bins 84 disposed on opposing side walls 40 of the storage bin 30. Particularly, each of the pair of side bins 84 extends from one of the side walls 40 away from the storage space 46 and includes a side floor 100 defining a cavity 102. The side floor 100 is configured to be substantially flush with the floor panel 18 of the vehicle 12 when the storage bin 30 is secured within the floor panel 18. The cavity 102 has a quadrilateral shape and is recessed with respect to the side floor 100. In some embodiments, the cavities 102 of each of the side bins 84 of the storage bin 30 may span the entire side floor 100. In other embodiments, the cavities 102 may form another shape or be positioned at another location on the side floors 100.

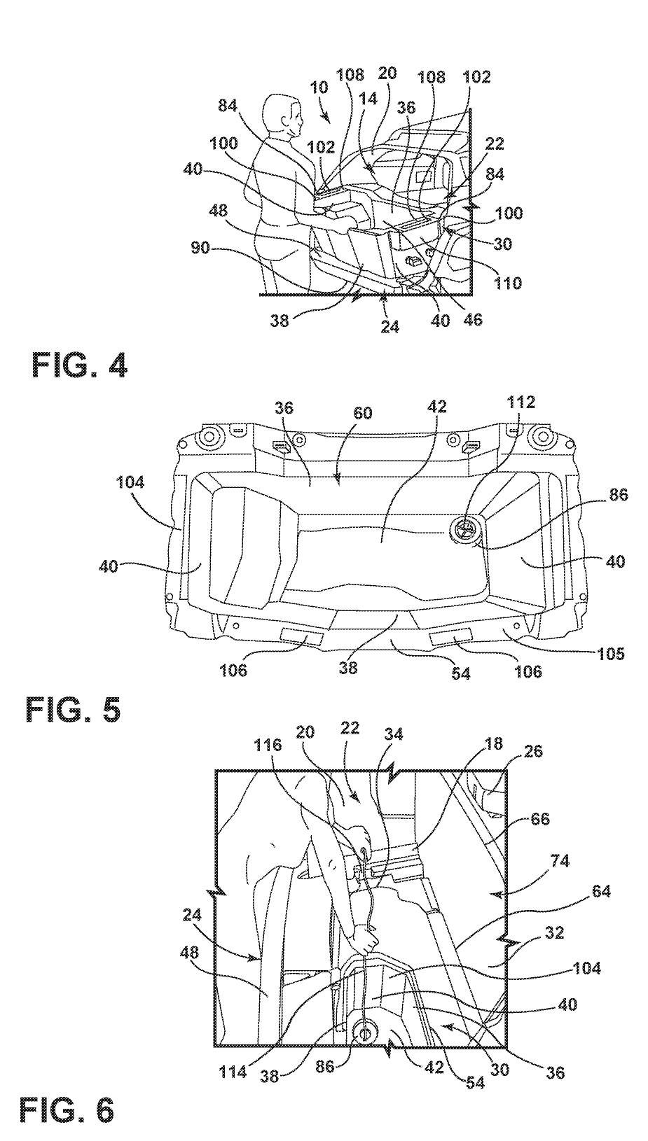

With reference now to FIGS. 4 and 5, the storage bin 30 is removed from the floor panel 18 of the vehicle 12. When the storage bin 30 is received by the floor panel 18, the storage bin 30 is removably coupled to the floor panel 18 in the storage area 22. In some embodiments, a portion of the storage bin 30 may be selectively removed from the floor panel 18. For example, a lower bin 104 of the storage bin 30 corresponding to the lower compartment 60 may be removable from the storage area 22 after the storage bin 30 is secured by the floor panel 18. In other embodiments, the lower bin 104 or the storage bin 30 may not be removable from the floor panel 18 of the vehicle 12 after installation during the manufacturing of the storage system 10. As such, the lower bin 104 and/or the storage bin 30 may be fixed to the floor panel 18 with a plurality of fasteners.

The lower bin 104 includes a lower rear surface 105 with two handle grips 106 configured to assist with disposing the storage bin 30 within the storage area 22. Specifically, the two handle grips 106 are configured to assist with installation of the lower bin 104 into the storage area 22 during the manufacturing of the storage system 10. When installed in the storage area 22, the lower rear surface 105 of the storage bin 30 is overlayed and/or secured by the liftgate scuff 48 such that the handle grips 106 are at least partially hidden under the liftgate scuff 48. In one embodiment, the handle grips 106 are overlayed by the liftgate scuff 48 such that the handle grips 106 are not disposed within the storage space 46. According to some embodiments of the vehicle storage system 10, the lower bin 104 of the storage bin 30 may have a different number of handle grips 106. Alternatively, the handle grips 106 may be disposed at a different location on the storage bin 30.

Referring to FIG. 4, another embodiment of the pair of side bins 84 is shown. Each of the pair of side bins 84 includes the side floor 100 and the cavity 102, the cavity 102 being recessed relative to the side floor 100. Additionally, each side bin 84 includes a side cover 108 and a side compartment 110, where the side cover 108 is substantially flush with the side floor 100, and where the side cover 108 is operable between a closed position and an open position. When the side cover 108 is in the closed position, the side cover 108 covers the side compartment 110 such that the side compartment 110 is isolated from the storage area 22 and the storage space 46. When the side cover 108 is in the open position, the side compartment 110 is in connection with the storage area 22. Each of the side covers 108 may further define side handles for moving the side covers 108 between the open and closed positions. Additionally, each of the side bins 84 may include the cavity 102 and not the side compartment 110, the side compartment 110 and not the cavity 102, or both the cavity 102 and the side compartment 110. In alternative embodiments, the side bins 84 may not be connected to the storage bin 30 and instead may be independently secured within the floor panel 18 in the storage area 22.

With reference to FIGS. 5 and 6, the bottom wall 42 of the storage bin 30 defines the drain port 86, and a drain valve 112 is removably received by the drain port 86. The front, rear, side, and bottom walls 36, 38, 40, 42 proximate the lower compartment 60 of the storage bin 30 comprise a waterproof material, such as plastic. In a use case where wet items or ice is stored in the lower compartment 60, the drain port 86 is configured to allow fluids to pass though the drain valve 112 and out of the storage space 46 of the vehicle 12, past the vehicle exterior 90 (FIG. 2). The drain valve 112 is a one-way valve, preventing fluid ingress into the storage space 46 from outside the vehicle 12 via the drain port 86. The drain valve 112 may also be removed from the drain port 86. When the drain valve 112 is removed from the drain port 86, the drain port 86 is configured to receive objects such as an electrical cord 114 such that an electrical device within the vehicle 12 can connect to an electrical component located exterior to the vehicle 12. The electrical device may be a device including but not limited to a personal electronic device, a component of the vehicle 12, or another auxiliary device. The electrical component may be a component including but not limited to a power source or a power outlet.

With reference to FIG. 6, the rim 44 of the storage bin 30 may further define a power cord channel 116 configured to receive the electrical cord 114. When the drain valve 112 has been removed from the drain port 86, and the electrical cord 114 is received by the drain port 86, the electrical cord 114 may also be received by the power cord channel 116 such that the electrical cord 114 is provided at both the vehicle exterior 90 and the storage area 22 of the vehicle 12 when the load floor 32 is in the second or third positions 72, 74. Notably, it is contemplated that the power cord channel 116 may further be defined in the intermediate ridge 54 such that the electrical cord 114 may electrically connect an electrical component exterior to the vehicle 12 to an electrical device in the interior space 14 of the vehicle 12 when the load floor 32 is in the first position 70.

The vehicle storage system 10 disclosed herein provides a number of advantages, including an increased stability of a multi-purpose storage solution, as the storage bin 30 disclosed herein may be secured within the floor panel 18 in the storage area 22, to the climate control ducts 52, and/or to vehicle tie downs. Furthermore, the vehicle storage system 10 provides for an adjustable storage solution that users can customize based on each use case. For example, when the load floor 32 is in the first position 70, the lower compartment 60 of the storage bin 30 may be ideal for storing smaller items, such as sports equipment, shoes, and small bags. The storage area volume is increased when the load floor 32 is in the first position 70 as compared to the second position 72, which may allow the storage area 22 to better accommodate larger items, such as a stroller and larger bags and equipment. Having the load floor 32 in the second position 72 maximizes the storage space 46 within the storage bin 30 and may be ideal for storing standard-sized luggage and/or suitcases. Plants, golf clubs, and other tall items may be best received by the vehicle 12 when the load floor 32 is exposing the storage space 46 to the storage area 22 in the third position 74. Moreover, the vehicle storage system 10 is configured to receive wet items, as fluid egress is provided by the drain port 86 in the lower compartment 60 of the storage bin 30. The drain port 86 may be configured to remove water from the storage bin 30 at a rate of 80-90 liters per minute.

The vehicle storage system 10 further enables the storage bin 30 to be used as a cooler. A user can add ice, food, and drinks to the storage space 46 of the storage bin 30, as the storage bin 30, at least in the lower compartment 60, is waterproof and provides the drain valve 112 for fluid egress. Notably, the drain valve 112 is a one-way drain valve that prevents water ingress into the storage space 46. The storage space volume may measure to be 170 or more liters under the load floor 32, the storage bin 30 also potentially providing 100 or more liters of waterproof storage space volume.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A storage system, comprising:
a storage bin having a front wall, a rear wall, a pair of laterally spaced side walls, a bottom wall, and a rim defining a top access opening, wherein the storage bin is coupled to a storage area of a vehicle, the storage bin defining a storage space including:
a lower compartment;
an upper compartment located above the lower compartment; and
a load floor configured to:
separate the storage space into the upper and lower compartments when the load floor is in a first position;
separate the storage area from the storage space of the storage bin when the load floor is in a second position; and
uncover the top access opening to expose the storage space to the storage area when the load floor is in a third position;
wherein the load floor is removably coupled to the bin in the first, second, and third positions, and wherein the load floor extends substantially vertically when in the third position.

2. The storage system of claim 1, further comprising:
a protuberance extending laterally into the storage space of the storage bin from each of the pair of laterally spaced side walls, wherein the pair of protuberances are spaced from the front wall, and wherein the pair of protuberances are configured to support the load floor.

3. The storage system of claim 2, wherein:
the load floor is positioned below the pair of protuberances in the first position;
the load floor rests on the pair of protuberances in the second position; and
the load floor interposes the pair of protuberances and the front wall in the third position.

4. The storage system of claim 1, further comprising:
a pair of side bins extending from the pair of laterally spaced side walls away from the storage space, wherein each of the pair of side bins has a side compartment and a side cover configured to separate the storage area and the side compartment.

5. The storage system of claim 1, wherein the storage bin proximate the side walls is configured to couple to a climate system duct provided on a side panel of the vehicle.

6. The storage system of claim 1, wherein the bottom wall of the storage bin has a drain port connecting a vehicle exterior with the storage space, wherein a one-way drain valve is removably secured in the drain port, and wherein the drain port is configured to receive an electrical cord that is external to the vehicle when the one-way drain valve is removed from the drain port.

7. The storage system of claim 1, wherein the storage bin provides an intermediate ridge, wherein the intermediate ridge is situated below the pair of protuberances, and wherein the intermediate ridge is configured to receive the load floor in the first position.

8. The storage system of claim 3, wherein the storage bin provides at least one handle grip situated on the rim of the storage bin, wherein the at least one handle grip is disposed under a liftgate scuff of the vehicle such that the at least one handle grip is hidden from view by a user.

9. A vehicle storage system, comprising:
a storage bin provided in a storage area of a vehicle, wherein the storage area is at least partially defined by a floor panel of the vehicle and a pair of side panels of the vehicle, the storage bin further including:
a front wall, a rear wall, a pair of laterally spaced side walls, a bottom wall, a rim defining a top access opening, and an intermediate ridge interposing the bottom wall and the rim, wherein the storage bin is secured in the storage area;
a storage space defined by the storage bin, the storage space including:
a lower compartment;
an upper compartment located above the lower compartment; and
a pair of protuberances laterally extending into the storage space from the pair of laterally spaced side walls, wherein the pair of protuberances are spaced from the front wall; and
a load floor configured to:
lay on the intermediate ridge of the storage bin below the pair of protuberances and thereby partition the storage space into the upper and lower compartments when the load floor is in a first position;
lay on the rim and thereby separate the storage area of the vehicle from the upper and lower compartments of the storage bin when the load floor is in a second position; and
interpose the front wall and the pair of protuberances when in a vertical orientation and thereby uncover the top access opening to expose the storage space to the storage area when the load floor is in a third position;
wherein the load floor is removably coupled to the bin in the first, second, and third positions.

10. The vehicle storage system of claim 9, wherein the load floor has a handle situated proximate the rear wall when the load floor is in the first and second positions, and wherein the handle is positioned away from the storage bin when the load floor is in the third position.

11. The vehicle storage system of claim 10, wherein the load floor is flush with the floor panel of the vehicle when the load floor is in the second position.

12. The vehicle storage system of claim 11, further comprising:
a side bin extending from at least one of the pair of laterally spaced side walls away from the storage space, wherein the side bin includes a side compartment and a side cover configured to lay flush with the floor panel.

13. The vehicle storage system of claim 9, wherein the storage bin further includes a support conduit extending laterally along the front wall between a pair of orifices, and wherein the orifices are configured to couple to a climate system duct located on each of the pair of side panels of the vehicle.

14. The vehicle storage system of claim 9, wherein the bottom wall of the storage bin defines a drain port configured to removably receive a drain valve, and wherein the drain port is configured to receive an electrical cord extending from a vehicle exterior when the drain valve is not received by the drain port.

15. The vehicle storage system of claim 9, wherein at least one handle grip is disposed on the storage bin proximate the rear wall, and wherein the at least one handle grip is disposed under a liftgate scuff of the vehicle.

16. A storage system, comprising:
a storage area of a vehicle defined by a floor panel, a pair of opposing side panels, a top panel, and a rear seating assembly;
a storage bin having a front wall, a rear wall, a pair of laterally spaced side walls, a bottom wall, and a top access opening, wherein the front wall, the rear wall, and the pair of laterally spaced side walls define a rim of the storage bin at the top access opening, and wherein the storage bin is coupled to the storage area of the vehicle;
a storage space within the storage bin, the storage space having an upper compartment, a lower compartment, and a pair of protuberances spaced from the front panel and extending laterally into the storage space from the pair of laterally spaced side walls; and
a load floor operable between:
a first position, wherein the load floor is disposed below the pair of protuberances, separating the storage space into the upper and lower compartments;
a second position, wherein the load floor is supported by the rim, connecting the upper and lower compartments and separating the storage area of the vehicle from the storage space of the storage bin; and
a third position, wherein the load floor is secured between the front panel and the pair of protuberances, exposing the storage space to the storage area;
wherein a handle is disposed on the load floor, wherein the handle is situated proximate the rear wall of the storage bin when the load floor is in the first and second positions, and wherein the handle is situated away from the rear wall when the load floor is in the third position.

17. The storage system of claim 16, wherein the load floor is substantially flush with the floor panel when the floor panel is in the second position.

18. The storage system of claim 17, wherein the storage bin further comprises a pair of side bins extending laterally from the pair of laterally spaced side walls, wherein each of the pair of side bins has a side cover configured to lay substantially flush with the floor panel.

19. The storage system of claim 18, wherein the bottom wall of the storage bin defines a drain port configured to removably receive a drain valve, and wherein the drain port is further configured to removably receive an electrical cord that is external to the vehicle when the drain valve has been removed from the drain port.

20. The storage system of claim 19, wherein the storage bin provides an intermediate ridge situated below the pair of protuberances within the storage space, wherein the intermediate ridge substantially demarcates the upper and lower compartments of the storage bin, and wherein the load floor is configured to lay on the intermediate ridge when in the first position.
